(19) United States
(12) Patent Application Publication
(10) Pub. No.: US 2026/0371040 A1
(43) Pub. Date: Nov. 19, 2026

(54) SENSING CHARGING SUBSCRIPTION

(71) Applicant: QUALCOMM Incorporated, San Diego, CA (US)

(72) Inventors: Preeti Kumari, San Diego, CA (US); Hong Cheng, Basking Ridge, NJ (US); Kapil Gulati, Belle Mead, NJ (US); Junyi Li, Greentown, PA (US); Stelios Stefanatos, San Diego, CA (US); Shijun Wu, San Diego, CA (US)

(21) Appl. No.: 19/133,961

(22) PCT Filed: Dec. 5, 2023
(86) PCT No.: PCT/US2023/082496

§ 371 Date: May 29, 2025

(30) Foreign Application Priority Data
Jan. 31, 2023 (GR) 20230100074

(51) Int. Cl. H04W 4/24; H04M 15/00

(52) U.S. Cl. CPC H04W 4/24; H04M 15/8207

(57) ABSTRACT

This disclosure provides systems, methods, and devices for wireless communication that support a sensing charging subscription. In a first aspect, a method of wireless communication includes performing a monostatic sensing operation. The method also includes generating charging information associated with the monostatic sensing operation, the charging information associated with sensing charging subscription information. Other aspects and features are also claimed and described.

### CROSS-REFERENCE TO RELATED APPLICATIONS

This application claims the benefit of Greek Patent Application No. 20230100074, entitled, “SENSING CHARGING SUBSCRIPTION,” filed on Jan. 31, 2023, which is expressly incorporated by reference herein in its entirety.

### TECHNICAL FIELD

Aspects of the present disclosure relate generally to wireless communication systems, and more particularly, to a sensing charging subscription, such as a sensing charging subscription associated with a monostatic sensing operation. Some features may enable and provide sensing operation management and control, reduced overhead signaling, efficient spectrum usage, reduced device hardware, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Conventional 3GPP systems are configured to manage communication-based subscription charges, such as communication charges for NR communication. To illustrate, a 3GPP system may use or implement online charging, which is a mechanism where charging information can affect, in real-time, the service rendered. The online charging for communication-based subscriptions may be event-based or session-based. To implement the online charging, a direct interaction between the charging mechanism and control of network resource usage. Although the 3GPP systems are configured to manage the communication-based subscription charges, the 3GPP systems are not configured to manage and charge for sensing services, such as long range or short-range sensing, that may be offered over 5G.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes performing a monostatic sensing operation. The method also includes generating charging information associated with the monostatic sensing operation. The charging information is associated with sensing charging subscription information.

In an additional aspect of the disclosure, an apparatus includes at least one processor and a memory coupled to the at least one processor. The at least one processor is configured to perform a monostatic sensing operation. The at least one processor is further configured to generate charging information associated with the monostatic sensing operation. The charging information is associated with sensing charging subscription information.

In an additional aspect of the disclosure, an apparatus includes means for performing a monostatic sensing operation. The apparatus further includes means for generating charging information associated with the monostatic sensing operation. The charging information is associated with sensing charging subscription information.

In an additional aspect of the disclosure, a non-transitory computer-readable medium stores instructions that, when executed by a processor, cause the processor to perform operations. The operations include performing a monostatic sensing operation. The operations further include generating charging information associated with the monostatic sensing operation. The charging information is associated with sensing charging subscription information.

In one aspect of the disclosure, a method for wireless communication is performed by a network entity. The method includes receiving charging information associated with a monostatic sensing operation performed by a UE. The charging information is associated with sensing charging subscription information. The method further includes generating a sensing charge based on the charging information.

In an additional aspect of the disclosure, an apparatus includes at least one processor and a memory coupled to the at least one processor. The at least one processor is configured to receive charging information associated with a monostatic sensing operation performed by a UE. The charging information is associated with sensing charging subscription information. The at least one processor is further configured to generate a sensing charge based on the charging information.

In an additional aspect of the disclosure, an apparatus includes means for receiving charging information associated with a monostatic sensing operation performed by a UE. The charging information is associated with sensing charging subscription information. The apparatus further includes means for generating a sensing charge based on the charging information.

In an additional aspect of the disclosure, a non-transitory computer-readable medium stores instructions that, when executed by a processor, cause the processor to perform operations. The operations include receiving charging information associated with a monostatic sensing operation performed by a UE. The charging information is associated with sensing charging subscription information. The operations further include generating a sensing charge based on the charging information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports a sensing charging subscription according to one or more aspects.

FIG. 5 is a flow diagram illustrating an example process that supports a sensing charging subscription according to one or more aspects.

FIG. 6 is a block diagram of an example UE that supports a sensing charging subscription according to one or more aspects.

FIG. 7 is a flow diagram illustrating an example process that supports a sensing charging subscription according to one or more aspects.

FIG. 8 is a block diagram of an example base station that supports a sensing charging subscription according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support a sensing charging subscription. For example, the present disclosure describes sensing charging subscription information that is associated with a sensing charging subscription for a user equipment (UE) configured to perform a sensing operation, such as monostatic sensing. To illustrate, the UE may perform a sensing operation, such as a monostatic sensing operation, and may generate charging information associated with the monostatic sensing operation. The charging information may be associated with or generated based on sensing charging subscription information. The sensing charging subscription information may include or define the sensing charging subscription, such as a sensing charging subscription model. The sensing charging subscription, such as the sensing charging subscription model, may indicate that sensing charging (e.g., a charge associated with a sensing operation by the UE) may be UE-based, based on a sensing service usage report, quota-based (e.g., threshold-based), event-based, or a combination thereof. Additionally, or alternatively, the UE may generate a sensing usage report for mode-1 operation (where one or more operations of the UE is scheduled by a base station) or mode-2 operation (where the UE is configured to autonomously select a resource for one or more operation) by the UE. Mapping between user requirements and sensing resource utilization: Static or dynamic mapping. Charging with reservation, such as concurrent reservation/sensing or sequential reservation/sensing.

Particular implementations of the subject matter described in this disclosure may be implemented to realize one or more of the following potential advantages or benefits. In some aspects, the present disclosure provides techniques for supporting a sensing charging subscription. For example, the techniques described provide techniques, information, and signaling for the UE to perform sensing operations according to a sensing subscription. A system, such as a 3GPP system may advantageously manage sensing based subscription charges for the sensing operations or services, such as 5G or NR sensing services, associated with the UE. The techniques described herein enable reduced overhead, efficient spectrum usage, improved spectrum reuse, reduced device hardware, improved hardware reuse, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 millisecond (ms)), and users with wide ranges of mobility or lack thereof; and (3) with enhanced mobile broadband including extreme high capacity (e.g., ~10 Tbps/km² ), extreme data rates (e.g., multi-Gbps rate, 100 + Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR 1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

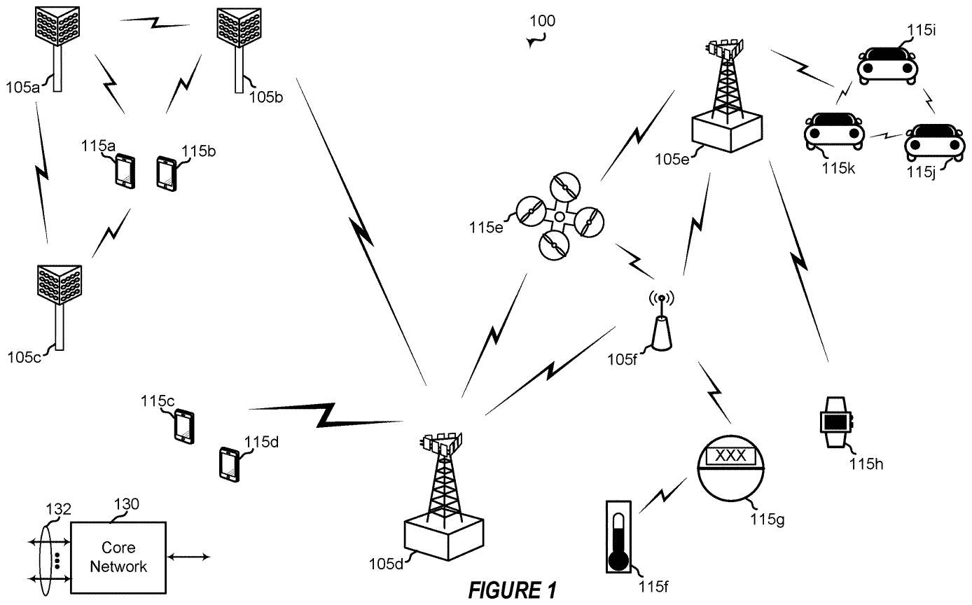

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IOT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF), which is an entity in the 5G Core Network (5GC) supporting various functionality, such as managing support for different location services for one or more UEs. For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

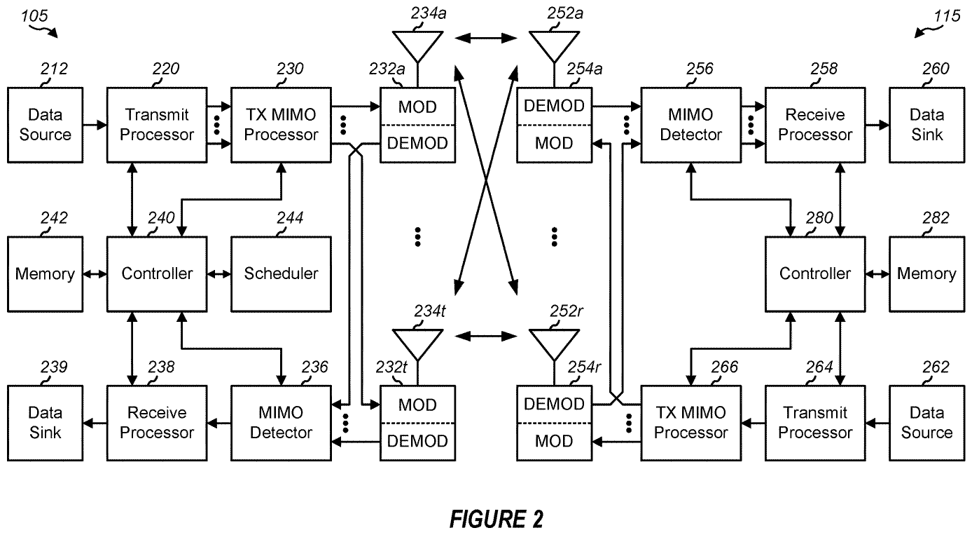

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 1-8, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

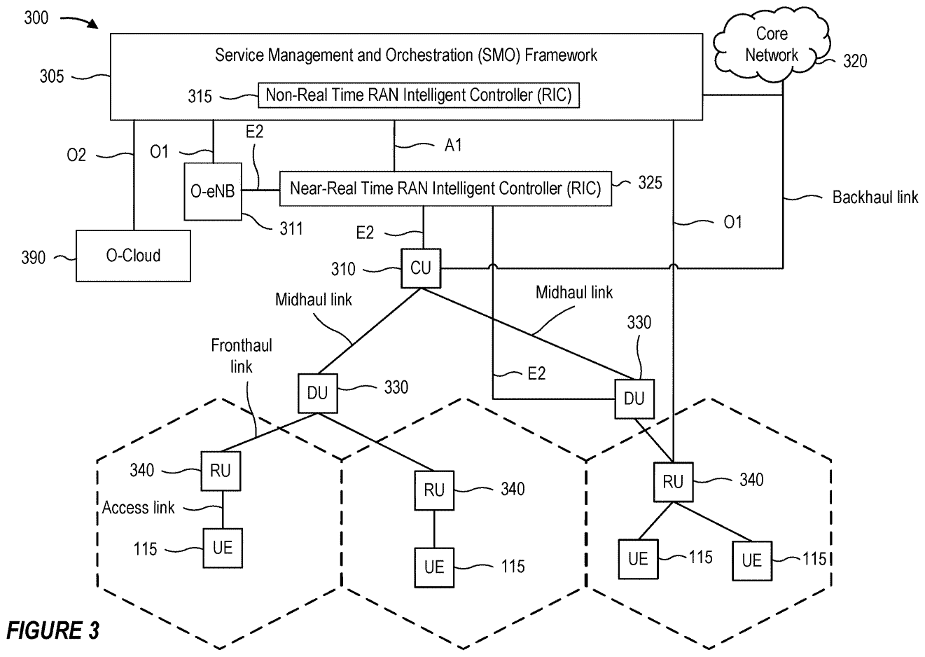

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

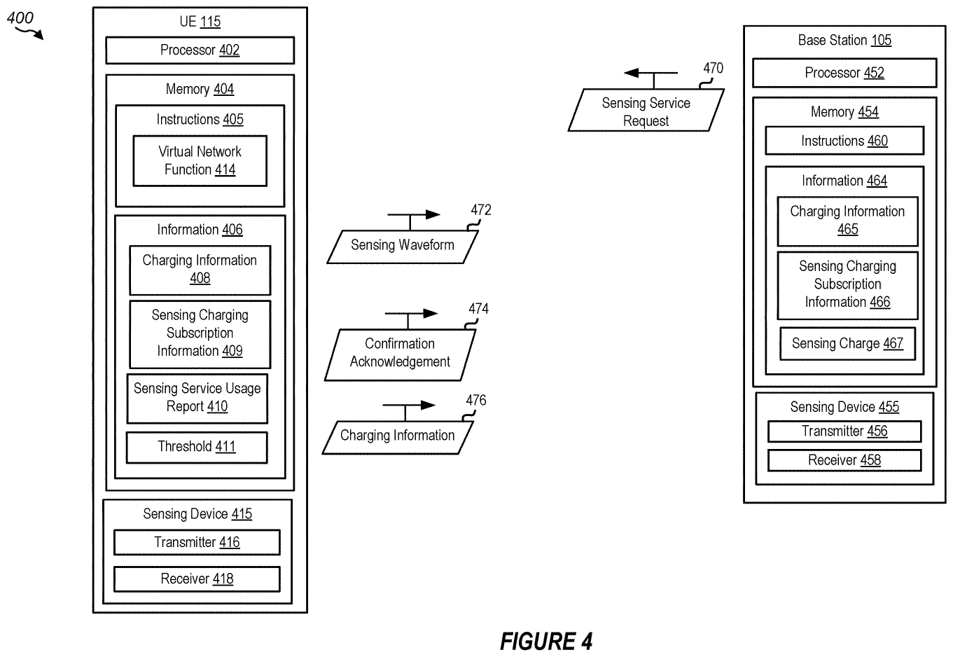

FIG. 4 is a block diagram of an example wireless communications system 400 that supports a sensing charging subscription according to one or more aspects. In some examples, wireless communications system 400 may implement aspects of wireless network 100. Wireless communications system 400 includes UE 115 and base station 105. Although one UE 115 and one base station 105 are illustrated, in some other implementations, wireless communications system 400 may generally include multiple UEs 115, multiple base station 105, or a combination thereof.

UE 115 may include a device, such as a mobile device or a vehicle. UE 115 may be configured to performing sensing using one or more uplink (UL) resources. For example, when UE 115 is a vehicle, UE 115 may perform one or more sensing operations to sense an environment, such as an indoor environment of the vehicle or an outdoor environment of the vehicle. To illustrate, UE 115 may sense for surrounding objects for automotive applications, such as collision avoidance. To enable UE side sensing, such as a joint communication and radar (JCR) sensing, the UL resources (e.g., communication resources) can be reused for sensing. For example, the UL resources may be shared between communication and radar modes. To illustrate, in some implementations, there could be separate resources for communication or radar that are used based on a TDM mode. In some such implementations, an SRS can be utilized as a sensing waveform. Alternatively, the same resource for communication and radar may be used that has a join co-design waveform.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), and one or more sensing devices 415 (hereinafter referred to collectively as “sensing device 415”). Sensing device 415 may include or correspond to a monostatic sensing device. In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, charging information 408, sensing charging subscription information 409, sensing service usage report 410, and one or more thresholds 411 (hereinafter referred to collectively as “threshold 411”). Instructions 405 include a virtual network 414. Virtual network function 414 may include a charging trigger function (CTF). In some implementations virtual network function 414 is configured to receive a sensing service usage request and to generate one or more trigger events based on the sensing service usage request.

Charging information 408 may include information based on a monostatic sensing operation performed by UE 115. For example, charging information 408 may include or indicate one or more measurements of the monostatic sensing operation, one or more parameters (e.g., a transmit power, a resource, a resource pool, a bandwidth, a sensing quality of service, a mode of operation, a sensing time period or time domain, a beam direction, a beam bandwidth, etc.) of the monostatic sensing operation, an indicator that the monostatic sensing operation was completed, a trigger event associated with the monostatic sensing operation, a state of a multi-stage sensing operation, or a combination thereof. Sensing charging subscription information 409 may include or indicate a sensing subscription associated with one or more sensing operations or one or more sensing services. The sensing subscription may include or indicate a functionality, a rule, a profile, a model, or a combination thereof. In some implementations, the sensing subscription is associated with or based on an agreement, such as a contract, that identifies or defines the sensing subscription of multiple available sensing subscriptions. Sensing service usage report 410 may include or indicate the sensing service usage report indicates a time domain parameter, a frequency domain parameter, a beam direction, a beam bandwidth, a power transmission over time-frequency-space, a quality of service, a resource pool, or a combination thereof. In some implementations charging information 408 may include or indicate sensing service usage report 410.

Threshold 411 may include or indicate one or more values or rages. In some implementations, threshold 411 is associated a resource, power, a sensing quality of service, or a combination thereof.

Sensing device 415 includes one or more transmitters 416 (hereinafter referred to collectively as “transmitter 416”), and one or more receivers 418 (hereinafter referred to collectively as “receiver 418”). Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2. In some implementations, sensing device 415 is associated with a joint communication and radar (JCR) system. The JCR system may be categorized as a cooperative JCR system or a co-design of communication and radar systems. For example, sensing device 415 may be associated with the co-design of communication and radar systems.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

UE 115 may include one or more components as described herein with reference to UE 115. In some implementations, UE 115 is a 5G-capable UE, a 6G-capable UE, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), and one or more sensing devices 455 (hereinafter referred to collectively as “sensing device 455”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 354 includes or is configured to store instructions 460 and information 464. Information 464 may include charging information 465, sensing charging subscription information 466, and sensing charge 467. Charging information 465 may include or correspond to charging information 408 or sensing service usage report 410. Sensing charging subscription information 466 may include or correspond sensing charging subscription information 409. Sensing charge 467 may include or correspond to a charge, such as a fee or a cost, of a sensing service associated with or used by UE 115.

Sensing device 455 includes one or more transmitters 416 (hereinafter referred to collectively as “transmitter 456”), and one or more receivers 418 (hereinafter referred to collectively as “receiver 458”). Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

In some implementations, UE 115 or sensing device 415 may be associated with a JCR system. The JCR system provide advantages and benefits of at least helping radar or radar helping communication, spectrum reuse, hardware reuse, or a combination thereof. The JCR system may be categorized as a cooperative JCR system or a co-design of communication and radar systems. In the cooperative JCR system, information may be shared between the communication and radar systems to improve performance, without much altering core operation of radar and communication systems. The cooperative JCR system provides advantages and benefits of at least spectrum reuse and ease of implementation. In the co-design of communication and radar systems, a common transmitter or receiver is used for both communication and radar functionalities. The co-design of communication and radar systems may require modification in the transmit waveform generation or the receiver processing of both or either of the systems. The co-design of communication and radar systems provide advantages and benefits of at least reduced hardware and spectrum reuse.

In some implementations, UE 115 may implement a multi-stage sensing, such as a two-stage UL sensing that includes a scanning stage and a tracking stage. In an automotive or vehicular application, high density of vehicular radars with high-resolution and high update-rate may be used for sensing operations. As a single-stage UL sensing transmission may lead to large communication overhead, UE 115 may implement a two-stage UL sensing with scanning (SCAN) and tracking (TRACK) phase to enable radar sensing with low overhead. To illustrate, the two-stage sensing may support multi-radar sensing over shared UL communication resources with low overhead.

For NR communications, a charging system may be used that enables online charging. Online charging is a mechanism where charging information can affect, in real-time, the service rendered and therefore a direct interaction of the charging mechanism with the control of network resource usage is required. Online charging may include a process where charging information for network resource usage is collected concurrently with that resource usage in the same fashion as in offline charging. In some implementations, authorization for the network resource usage must be obtained by or from the network prior to the actual resource usage to occur by UE 115. This authorization may be granted by an online charging system (OCS) or a converged charging system (CCS) upon request from the network. In some implementations, the OCS or the CCS may be located at the network, such as base station 105 or core network 130.

The network may receive a network resource usage request and, based on the network resource usage request, assembles the relevant charging information and generates a charging event towards the OCS or CCS. For example, the charging event may be generated in real-time. The OCS or the CCS may then return an appropriate resource usage authorization. The resource usage authorization may be limited in its scope (e.g., volume of data or duration), therefore the authorization may have to be renewed from time to time as long as the user's network resource usage persists.

In some implementations, the charging system may include or use an event-based charging function (EBCF). The EBCF may function within the OCS and may be used to charge events based on an occurrence of an event rather than a duration or a volume used in the event. Examples, of an event include are SMS, MMS, or purchase of content (application, game, music, video on demand, etc.). The EBCF may be configured to perform event-based charging and credit-control (e.g. content charging) on a bearer level, on a subsystem level, or on a service level. For example, on the bearer level, the EBCF may perform the event-base charging based on bearer usage requests received from the network such that the EBCF controls the bearer usage in the network, e.g. SMS. As another example, on a subsystem level, the EBCF may perform the event-base charging based on session resource usage requests received from the network (e.g. the IMS MRFC) such that the EBCF controls the resource availability in network, e.g. it has the ability to grant or deny the resource usage. As another example, on service level, the EBCF may perform the event-base charging based on application server requests received from the network (e.g. an IMS application server or MMS relay server) such that the EBCF controls the application service availability in the network, e.g. it has the ability to grant or deny the service usage in the network. The EBCF may communicate with a rating function in order to determine the value of the requested service usage and may communicate with an account balance management function (ABMF) to query and update an account and counters status of a subscriber.

In some implementations, the charging system may include or use a session-based charging function (SBCF). The SBCF may be configured to functions within the OCS. The SBCF may be responsible for online charging of network/user sessions, such as voice calls, IP CAN bearers, IP CAN session or IMS sessions. It is noted that utility services, such as electricity or water, may be charged based on overall usage, for a certain time duration. The SBCF may be configured to perform session based charging and Credit-Control on the bearer level, on the subsystem level, or on the service level. For example, on the bearer level, the SBCF may perform the session-base charging based on bearer usage requests received from the network such that the SBCF controls the bearer usage in the network, e.g. in terms of time or volume granted. As another example, on the subsystem level, the SBCF may perform the session-base charging based on session resource usage requests received from the network (e.g. the IMS CSCF) such that the SBCF controls sessions in the network, e.g. it has the ability to grant or deny a session setup request and to terminate an existing session. As another example, on the service level, the SBCF may perform the session-base charging based on service usage requests received from the network such that the SBCF controls service availability in the network, e.g. it has the ability to grant or deny a usage of a service. The SBCF may communicate with a rating function in order to determine the value of the requested bearer resources or the requested session. Additionally, or alternatively, the SBCF may communicate with an ABMF to query and update an account and counters status of a subscriber.

In some implementations, sensing charging subscription information 409 is associated with sensing charging subscription for UE 115 configured to perform monostatic sensing UE. For example, sensing charging subscription information 409 may include or define the sensing charging subscription, such as a sensing charging subscription model. The sensing charging subscription, such as the sensing charging subscription model, may indicate that sensing charging (e.g., a charge associated with a sensing operation by UE 115) may be UE-based, based on a sensing service usage report, quota-based (e.g., threshold-based), event-based, or a combination thereof.

In some implementations, the sensing charging subscription may indicate that sensing charging may be UE-based. For example, UE 115 may include virtual network function 414, such as the CTF. UE 115 (e.g., virtual network function 414) may be configured to collect one or more sensing service usage request. The sensing service usage request may request UE 115 to perform one or more sensing operations, such as one or more sensing operations performed using sensing device 415. UE 115 may generate one or more trigger events based on the sensing service usage request. The one or more trigger events may be configured to trigger a sensing operation performed using sensing device 415.

In some implementations, the sensing charging subscription may indicate that sensing charging is based on sensing service usage report 410. For example, sensing charging may be based on sensing service usage report 410 when UE 115 is configured for mode-2 operations. During mode-2 operation, UE 115 may be configured to track one or more parameters associated with sensing operations and may generate sensing service usage report 410 based on the one or more parameters. In some implementations, charging information 408 may include or indicate the one or more parameters, sensing service usage report 410, or a combination thereof. Additionally, or alternatively, the sensing charging may be based on a sensing bearer, a service, or resource usage.

In some implementations, the sensing charging subscription may indicate that sensing charging is quota-based (e.g., threshold-based). In some implementations where sensing charging is quota-based, UE 115 may be configured to perform one or more actions (e.g., one or more operations) based on one or more quotas, such as one or more thresholds, included in or indicated by sensing charging subscription information 409. The one or more quotas may be associated with or defined in terms of a time period, a number of uses, a resource, a power, a sensing QoS, or a combination thereof. UE 115 may be configured to monitor or track usage of one or more parameters associated and compare the usage of the one or more parameters to the one or more quotas. UE 115 may perform one or more actions based on a determination of whether or not the one or more quotas is reached or exceeded. For example, based on a determination that a quota is reach or exceeded, UE 115 may be configured to perform a sensing operation at a lower QOS than a QoS before the quota is reached or exceeded. As another example, based on a determination that a quota is reach or exceeded, UE 115 may be configured to use the same QoS as before when the quota is reached or exceeded; however, sensing charging subscription information 409 may indicate an additional charge is applied for the same QoS. As another example, based on a determination that a quota is reach or exceeded, the action may include terminating a subscription-e.g., a sensing service or sensing operations are no longer available to UE 115. In some implementations, sensing charging could be event-based without a quota. For example, sensing charging subscription information 409 may be valid for a number of day or until a specific date. The one or more actions may be included in or indicated by sensing charging subscription information 409.

In some implementations, UE 115 may generate a sensing usage report (e.g., 410) for mode-1 operation (where one or more operations of UE 115 is scheduled by base station 105) or mode-2 operation (where UE 115 is configured to autonomously select a resource for one or more operation) by UE 115. A charge for a sensing service or one or more sensing operations performed by UE 115 may be determined based on the sensing usage report.

In some implementations, for UE 115 configured for mode-1 operation, UE 115 may generate confirmation acknowledgment 474, such as a confirmation ACK signal, to indicate that a sensing service is provided or has been provided. UE 115 may transmit confirmation acknowledgment 474 to base station 105. In some implementations, UE 115 may receive sensing service request 470 from base station 105. Sensing service request 470 may include or indicate an expected sensing QoS, a threshold QoS or a threshold range QoS, or a combination thereof. Confirmation acknowledgement 474 may indicate that a sensing service is provided or has been provided in accordance with sensing service request 470.

In some implementations, for UE 115 configured for mode-2 operation, UE 115 may generate the sensing usage report (e.g., 410). The sensing service usage report (e.g., 410) may include or indicate a time domain parameter, a frequency domain parameter, a beam direction, a beam bandwidth, a power transmission over time-frequency-space, a QoS (e.g., a QoS achieved), a sensing resource pool (e.g., a sensing resource pool used), or a combination thereof. The time domain parameter may include or indicate a start time of a sensing operation, a stop time of the sensing operation, a duration of the sensing operation, a comb pattern, a periodicity, or a combination thereof. The frequency domain parameter may include or indicate a start frequency of a sensing operation, a stop frequency of the sensing operation, a bandwidth of the sensing operation, a comb pattern, or a combination thereof. The QoS may include or indicate a resolution, a maximum span, a maximum number of targets detected, a minimum target signal to interference and noise ratio (SINR), intersection over union (IoU) metric, or a combination thereof.

In some implementations, a mapping may be performed between user requirements and sensing resource utilization of UE 115. The mapping may be performed by UE 115 or by base station 105. The mapping may be static or may be a dynamic mapping.

In some implementations, the mapping is static. For example, a static mapping may be based on an application, a sensing mode, a use case (e.g., a specific scenario or situation), or a combination thereof. For example, the mapping may be based on the sensing mode, such as a short-range radar sensing mode or short-range radar sensing operation, or a long-range radar sensing mode or long-range sensing operation. To illustrate, the long-range radar sensing mode or operation could map to a 300 m range, an azimuth field of view (FoV) of 30 degrees, a range resolution of 0.5 m, or a combination thereof. Alternatively, the short-range radar sensing could map to 30 m range (larger comb size in frequency domain than long-range radars), an azimuth FoV of 100 degrees, a range resolution of 0.1 m (larger bandwidth than long-range radars), or a combination thereof. As another example, the mapping may be based on the application, such as adaptive cruise control (ACC) or pre-crash. To illustrate, an update rate a sensing operation may be determined by the application-e.g., for an ACC application, the update rate for sensing is 100 ms and, for a pre-crash application, the update rate for sensing is 20 ms.

In some implementations, as another example of the static mapping, the mapping may be based on the stage of multiple sensing stages, such as two-stage sensing. For example, a first stage of the multiple sensing stages (e.g., the two-stage sensing) may be a scanning stage and a second stage of the multiple sensing stages (e.g., the two-stage sensing) may be a tracking stage. The scanning stage may map to a course resolution with small coherent processing interval and bandwidth. Alternatively, the tracking stage may map to fine resolution with large coherent processing interval and bandwidth. As another example of the static mapping, the mapping may be based on the use-case (e.g., a specific scenario or situation), such as indoor or outdoor sensing. To illustrate, outdoor sensing, as compared to indoor sensing, may have larger max velocity and max range requirement leading to smaller comb size in time-frequency domain.

In some implementations, the mapping is dynamic-e.g., there is a dynamic mapping between user requirements and sensing resource utilization. For example, a dynamic mapping may be associated with multiple phase sensing, such as a two-phase sensing, to enable dynamic mapping. To illustrate, a first stage may be associated with a rough or course sensing of an environment associated with UE 115. The first stage may be executed by base station 105, UE 115, or by a UE (not shown) other than UE 115. A result of the first stage may operate as a trigger or input for a subsequent stage, such as a second stage. To further explain, the result of the first stage may enable UE 115 or base station 105 to determine how to configure one or more resources of UE 115 to achieve a desired or required sensing quality during the second stage, such that one or more user requirements are met. In implementations where the first stage is performed by base station 105 or the other UE, the base station 105 or other UE may generate and send a measurement report for dynamic mapping. For example, the measurement report may be sent to base station 105 or UE 115. The measurement report may include or indicate a blockage location, a mobility of a nearby object or device, a congestion metric, such as a channel busy ratio (CBR) or a channel occupancy ratio (CR) for communication and sensing operations, or a combination thereof, as illustrative, non-limiting examples.

In some implementations, a charge for sensing operations performed by UE 115 may be determined for concurrent reservation or sequential reservation of sensing resource or operations. For example, the charge may be determined for concurrent sensing operations. To illustrate, UE 115 may be configured to perform concurrent sensing operations in which at least a portion of a short range sensing operation and at least a portion of a long range sensing operation overlap in time. The short range sensing operation may include an in-cabin sensing operation, the long range sensing operation may include an advanced driver assistance system (ADAS) sensing operation, or a combination thereof, as illustrative, non-limiting examples. As another example, the charge may be determined for sequential sensing operations. To illustrate, UE 115 may perform a first sensing operation followed by a second sensing operation. In some implementations, the first sensing operation may need to occur prior to the second sensing operation. For example, the first sensing operation may be an operation to sense a lane for a lane change prior to the second sensing operation to execute a left turn according to a navigation plan. As another example, the first sensing operation may include or correspond to a scanning stage and the second scanning operation may include or correspond to a tracking stage.

During operation of wireless communications system 400, UE 115 performs a monostatic sensing operation. For example, the monostatic sensing operation may be performed using sensing device 415. To perform the monostatic sensing operation, UE 115 transmits a sensing waveform 472, such as a sounding reference signal. UE 115 may receive a reflection of sensing waveform 472. UE 115 generates charging information 408 associated with or based on the monostatic sensing operation. The charging information is associated with sensing charging subscription information 409. UE 115 may transmit charging information 476 that includes or indicates charging information 408, sensing service usage report 410, or a combination thereof.

In some implementations, to perform the monostatic sensing operation, UE 115 may determine a user requirement and map the user requirement to a sensing resource, such as a sensing resource of sensing device 415. UE 115 may map the user requirement to the sensing resource is based on a sensing mode, an application, a stage of a multi-stage sensing operation, or a use case. UE 115 may use the sensing resource to perform the monostatic sensing operation.

In some implementations, UE 115 receives, from base station 105, a sensing service request 470. Sensing service request 470 indicates a quality of service, a threshold quality of service range, or a combination thereof. Additionally, or alternatively, the sensing service request may include or indicate one or more parameters associated with the monostatic sensing operation, such as a transmit power, a resource, a resource pool, a bandwidth, a sensing time period or time domain, a beam direction, a beam bandwidth, a trigger event, or a combination thereof, as illustrative, non-limiting examples. UE 115 may transmit a configuration acknowledgement signal that indicates that the monostatic sensing operation was performed based on the sensing service request 470.

In some implementations, UE 115 may be allocated a resource, such as a channel, by base station 105. For example, the resource may include or correspond to an uplink (UL) channel or a downlink (DL) channel. In other implementations, UE 115 may perform the monostatic sensing operation using the resource, such as the UL channel.

In some implementations, base station 105 or a network entity, such as core network 130, may determine a charge fee (e.g., 467) based on the monostatic sensing operation performed by UE 115. For example, base station 105 may determine the charge fee based on charging information 408, 465, or 476, sensing charging subscription information 466, or a combination thereof. In some implementations, base station 105 or the network entity is configured to communicate the sensing charge to a service provider of or associated with UE 115.

As described with reference to FIG. 4, the present disclosure provides techniques for supporting a sensing charging subscription. The techniques described provide processes, information, and signaling for UE 115 to perform sensing operations according to a sensing subscription. Wireless network 100 may advantageously manage sensing-based subscription charges for the sensing operations or services, such as 5G or NR sensing services, associated with UE 115. Additionally, the techniques described herein enable sensing operations performed by UE 115 may be managed or controlled according to the sensing subscriptions. By managing and controlling the sensing operations performed by UE 115, the techniques described herein enable reduced overhead, efficient spectrum usage, improved spectrum reuse, reduced device hardware, improved hardware reuse, or a combination thereof.

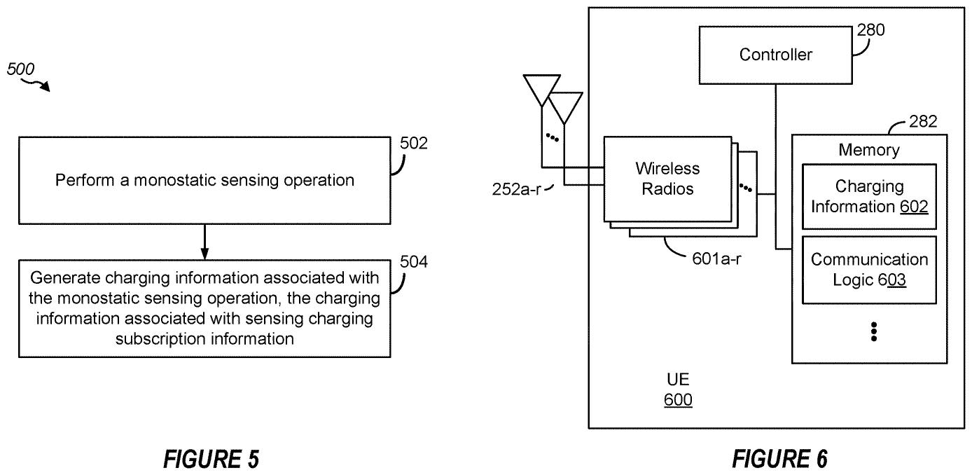

FIG. 5 is a flow diagram illustrating an example process 500 that supports a sensing charging subscription according to one or more aspects. Operations of process 500 may be performed by a UE, such as UE 115 described above with reference to FIGS. 1-4 or a UE described with reference to FIG. 6. For example, example operations (also referred to as “blocks”) of process 500 may enable UE 115 to support a sensing charging subscription.

In block 502, the UE performs a monostatic sensing operation. For example, the monostatic sensing operation may be performed using a sensing device, such as sensing device 415.

In block 504, the UE generates charging information associated with the monostatic sensing operation. For example, the charging information may include or correspond to charging information 408, charging information 465, or charging information 476. The charging information is associated with sensing charging subscription information. For example, the sensing charging subscription information may include or correspond to sensing charging subscription information 409 or 466. In some implementations, the sensing charging subscription information indicates a functionality, a rule, a profile, or a combination thereof.

In some implementations, the UE identifies the sensing charging subscription information associated with monostatic sensing operations. Additionally, or alternatively, the charging information is generated based on the sensing charging subscription information. The UE may transmit the charging information.

In some implementations, the UE receives, at a virtual network function of the UE, a sensing service usage request. For example, the virtual network function may include or correspond to instructions 405 or virtual network function 414. The virtual network function may include a CTF. The UE may generate one or more trigger events based on the sensing service usage request.

In some implementations, a sensing charge is generated based on the sensing charging subscription information. For example, the sensing charge may include or correspond to sensing charge 467. The sensing charge may be generated by the UE, by a base station (e.g., 105), by a network entity, or by core network 130. The sensing charge may also be generated based on a threshold, an action associated with the monostatic sensing operation is based on the threshold, or a combination thereof. The threshold may be associated a resource, power, a sensing quality of service, or a combination thereof. In some implementations, a value that includes or indicates the threshold is stored at memory 404 or 454. The action may be associated with a first quality of service, a charge based on a second quality of service, or termination of a subscription associated with the sensing charging subscription information.

In some implementations, the UE generates a sensing service usage report based on the monostatic sensing operation. For example, the sensing service usage report may include or correspond to sensing service usage report 410. The sensing service usage report may include or indicate a time domain parameter, a frequency domain parameter, a beam direction, a beam bandwidth, a power transmission over time-frequency-space, a quality of service, a resource pool, or a combination thereof. The UE may generate the sensing service usage report based on a mode-2 operation of the UE. In some implementations, the charging information includes the sensing service usage report. The sensing charge may further be generated based on the sensing service usage report. Additionally, or alternatively, the sensing charge is further generated based on a time period during which the sensing charging subscription information is valid. The UE may transmit the sensing service usage report, such as to base station 105.

In some implementations, the UE receives a sensing service request. For example, the sensing service request may include or correspond to sensing service request 470. The sensing service request may include or indicate a quality of service, a threshold quality of service range, or a combination thereof. The UE may transmit a configuration acknowledgement signal that indicates that the monostatic sensing operation was performed based on the sensing service request. The configuration acknowledgement signal may include or correspond to confirmation acknowledgement 474.

In some implementations, the UE determines a user requirement associated with the monostatic sensing operation. The UE may maps the user requirement to a sensing resource. mapping the user requirement to the sensing resource is based on a sensing mode, an application, a stage of a multi-stage sensing operation, or a use case. The sensing resource may be used to perform the monostatic sensing operation.

In some implementations, performing the monostatic sensing operation includes performing at least one stage of a multi-stage sensing operation. For example, to perform the monostatic sensing operation, the UE may perform a first stage of a multi-stage sensing operation, and determine a result based on the first stage of the multi-stage sensing operation. The result may include or indicate a blockage location, a mobility of an object, a congestion metric, or a combination thereof. The UE may map, based on the result, a user requirement to a sensing resource. Additionally, the UE may perform a second stage of the multi-stage sensing operation using the sensing resource.

In some implementations, to perform the monostatic sensing operation, the UE may receive, from a network entity, a report that indicates a result of a first stage of a multi-stage sensing operation. The result may include or indicate a blockage location, a mobility of an object, a congestion metric, or a combination thereof. The network entity may include or correspond to base station 105, core network 130, or another device. The UE may map, based on the result, a user requirement to a sensing resource. Additionally, the UE may perform a second stage of the multi-stage sensing operation using the sensing resource.

In some implementations, to perform the monostatic sensing operation, the UE may perform a first monostatic sensing operation, and perform a second monostatic sensing operation. The first monostatic sensing operation may be performed using a first sensing device, and the second monostatic sensing operation may be performed using a second sensing device. The first sensing device and the second sensing device may be the same device or may be different devices. The first monostatic sensing operation may be a short range sensing operation, the second monostatic sensing operation may be a long range sensing operation, or a combination thereof. The first monostatic sensing operation and the second monostatic sensing operation are performed concurrently. Alternatively, the second monostatic sensing operation is performed after the first monostatic sensing operation. To illustrate, the first monostatic sensing operation may be associated with a scanning stage, and the second monostatic sensing operation may be associated with a tracking stage.

FIG. 6 is a block diagram of an example UE 600 that supports a sensing charging subscription according to one or more aspects. UE 600 may be configured to perform operations, including the blocks of a process described with reference to FIG. 5. In some implementations, UE 600 includes the structure, hardware, and components shown and described with reference to UE 115 of FIGS. 1-4. For example, UE 600 includes controller 280, which operates to execute logic or computer instructions stored in memory 282, as well as controlling the components of UE 600 that provide the features and functionality of UE 600. UE 600, under control of controller 280, transmits and receives signals via wireless radios 601a-r and antennas 252a-r. Wireless radios 601a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include charging information 602 and communication logic 603. Charging information 602 may include or correspond to charging information 408, charging information 465, or charging information 476. Communication logic 603 may be configured to enable communication between UE 600 and one or more other devices. UE 600 may receive signals from or transmit signals to one or more network entities, such as base station 105 of FIGS. 1-4 or a network entity as illustrated in FIG. 8.

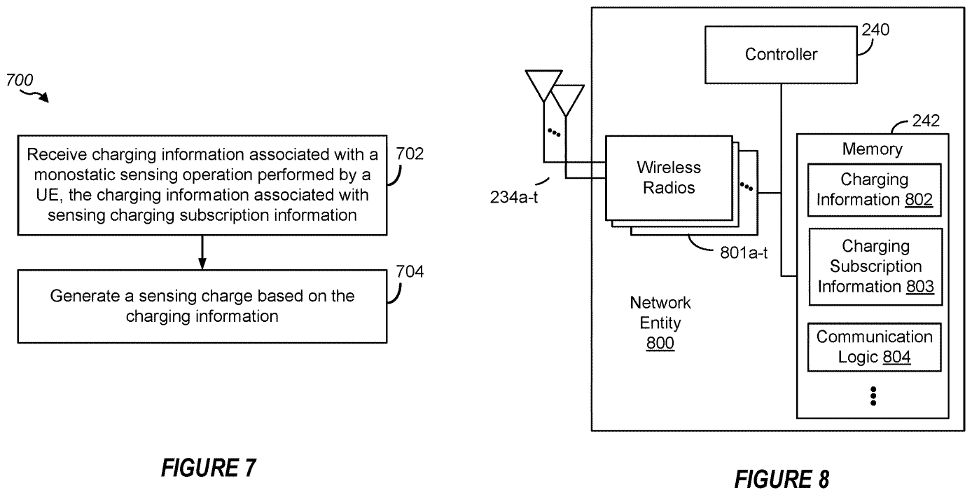

FIG. 7 is a flow diagram illustrating an example process 700 that supports a sensing charging subscription according to one or more aspects. Operations of process 700 may be performed by a network entity, such as base station 105 described above with reference to FIGS. 1-4 or a network as described above with reference to FIG. 8. For example, example operations of process 700 may enable the network entity to support a sensing charging subscription.

At block 702, the network entity receives charging information associated with a monostatic sensing operation performed by a UE. For example, the UE may include or correspond to UE 115. The charging information may include or correspond to charging information 408, charging information 465, or charging information 476. The charging information may be associated with sensing charging subscription information. For example, the sensing charging subscription information may include or correspond to sensing charging subscription information 409 or 466. In some implementations, the sensing charging subscription information includes or indicates a functionality, a rule, a profile, or a combination thereof.

At block 704, the network entity generates a sensing charge based on the charging information. The sensing charge may include or correspond to sensing charge 467.

In some implementations, the network entity identifies the sensing charging subscription information associated with monostatic sensing operations performed by the UE. Additionally, or alternatively, the sensing charge may be generated based on the sensing charging subscription information.

In some implementations, the sensing charge may additionally, or alternatively, be generated based on a threshold. an action associated with the monostatic sensing operation is based on the threshold, or a combination thereof. The threshold may be associated a resource, power, a sensing quality of service, or a combination thereof. The action is associated with: a first quality of service; a charge based on a second quality of service; or termination of a subscription associated with the sensing charging subscription information In some implementations, the network entity receives a sensing service usage report based on the monostatic sensing operation. For example, the sensing service usage report may be received from the UE. The sensing service usage report may have been generated based on a mode-2 operation of the UE. The network entity may generate the sensing charge based on the sensing service usage report. The sensing service usage report may include the charging information or other information. The sensing service usage report may indicate a time domain parameter, a frequency domain parameter, a beam direction, a beam bandwidth, a power transmission over time-frequency-space, a quality of service, a resource pool, or a combination thereof. Additionally, or alternatively, the sensing charge may be generated based on a time period during which the sensing charging subscription information is valid.

In some implementations, the network entity transmits a sensing service request. For example, the sensing service request may include or correspond to sensing service request 470. The sensing service request may indicate a quality of service, a threshold quality of service range, or a combination thereof. Additionally, or alternatively, the network entity may receive a configuration acknowledgement signal that indicates that the monostatic sensing operation was performed based on the sensing service request. For example, the confirmation acknowledgement signal may include or correspond to confirmation acknowledgement 474.

In some implementations, the monostatic sensing operation includes a multi-stage sensing operation. Additionally, or alternatively, the network entity may transmit a report that indicates a result of a first stage of a multi-stage sensing operation. The result may include or indicate a blockage location, a mobility of an object, a congestion metric, or a combination thereof.

FIG. 8 is a block diagram of an example network entity 800 that supports a sensing charging subscription according to one or more aspects. Network entity 800 may be configured to perform operations, including the blocks of process 700 described with reference to FIG. 7. In some implementations, network entity 800 includes the structure, hardware, and components shown and described with reference to base station 105 of FIGS. 1-4. For example, network entity 800 may include controller 240, which operates to execute logic or computer instructions stored in memory 242, as well as controlling the components of network entity 800 that provide the features and functionality of network entity 800. Network entity 800, under control of controller 240, transmits and receives signals via wireless radios 801a-t and antennas 234a-t. Wireless radios 801a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include charging information 802, charging subscription information 803, and communication logic 804. Charging information 802 may include or correspond to charging information 408, charging information 465, or charging information 476. Charging subscription information 803 may include or correspond to sensing charging subscription information 409 or 466. Communication logic 804 may be configured to enable communication between network entity 800 and one or more other devices. Network entity 800 may receive signals from or transmit signals to one or more UEs, such as UE 115 of FIGS. 1-4 or UE 600 of FIG. 6.

It is noted that one or more blocks (or operations) described with reference to FIG. 5 or 7 may be combined with one or more blocks (or operations) described with reference to another of the figures. For example, one or more blocks (or operations) of FIG. 5 may be combined with one or more blocks (or operations) of FIG. 7. As another example, one or more blocks associated with FIG. 5 or 7 may be combined with one or more blocks (or operations) associated with FIGS. 1-4. Additionally, or alternatively, one or more operations described above with reference to FIGS. 1-4 may be combined with one or more operations described with reference to FIG. 6 or 8.

In one or more aspects, techniques for supporting a sensing charging subscription may include additional aspects, such as any single aspect or any combination of aspects described below or in connection with one or more other processes or devices described elsewhere herein. In a first aspect, techniques for supporting a sensing charging subscription may include performing a monostatic sensing operation. The techniques may further include generating charging information associated with the monostatic sensing operation, the charging information associated with sensing charging subscription information. In some examples, the techniques in the first aspect may be implemented in a method or process. In some other examples, the techniques of the first aspect may be implemented in a wireless communication device, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the sensing charging subscription information indicates a functionality, a rule, a profile, or a combination thereof.

In a third aspect, in combination with the first aspect or the second aspect, the techniques further include transmitting the charging information.

In a fourth aspect, in combination with one or more of the first aspect through the third aspect, the techniques include identifying the sensing charging subscription information associated with monostatic sensing operations.

In a fifth aspect, in combination with the fourth aspect, the charging information is generated based on the sensing charging subscription information.

In a sixth aspect, in combination with one or more of the first aspect through the fifth aspect, the techniques include receiving, at a virtual network function of the UE, a sensing service usage request.

In a seventh aspect, in combination with ugh the sixth aspect, the techniques include generating one or more trigger events based on the sensing service usage request.

In an eighth aspect, in combination with the sixth aspect or the seventh aspect, the virtual network function, includes a CTF.

In a ninth aspect, in combination with one or more of the first aspect through the eighth aspect, a sensing charge is generated based on the sensing charging subscription information.

In a tenth aspect, in combination with the ninth aspect, the sensing charge is further generated based on a threshold, an action associated with the monostatic sensing operation is based on the threshold, or a combination thereof.

In an eleventh aspect, in combination with the tenth aspect, the threshold is associated a resource, power, a sensing quality of service, or a combination thereof.

In a twelfth aspect, in combination with one or more of the first aspect through the eleventh aspect, the action is associated with a first quality of service, a charge based on a second quality of service, or termination of a subscription associated with the sensing charging subscription information.

In a thirteenth aspect, in combination with one or more of the ninth aspect through the twelfth aspect, the techniques include generating a sensing service usage report based on the monostatic sensing operation.

In a fourteenth aspect, in combination with the thirteenth aspect, the sensing charge is further generated based on the sensing service usage report.

In a fifteenth aspect, in combination with the thirteenth aspect or the fourteenth aspect, the sensing charge is further generated based on a time period during which the sensing charging subscription information is valid.

In a sixteenth aspect, in combination with the thirteenth aspect or the fourteenth aspect, the sensing service usage report is generated based on a mode-2 operation of the UE.

In a seventeenth aspect, in combination with the thirteenth aspect or the fourteenth aspect, the sensing service usage report indicates a time domain parameter, a frequency domain parameter, a beam direction, a beam bandwidth, a power transmission over time-frequency-space, a quality of service, a resource pool, or a combination thereof.

In an eighteenth aspect, in combination with one or more of the first aspect through the seventeenth aspect, the techniques include receiving a sensing service request.

In a nineteenth aspect, in combination with the eighteenth aspect, the techniques include transmitting a configuration acknowledgement signal that indicates that the monostatic sensing operation was performed based on the sensing service request.

In a twentieth aspect, in combination with the nineteenth aspect, the sensing service request indicates a quality of service, a threshold quality of service range, or a combination thereof.

In a twenty-first aspect, in combination with one or more of the first aspect through the twentieth aspect, the techniques include determining a user requirement associated with the monostatic sensing operation.

In a twenty-second aspect, in combination with the twenty-first aspect, the techniques include mapping the user requirement to a sensing resource.

In a twenty-third aspect, in combination with the twenty-second aspect, the sensing resource is used to perform the monostatic sensing operation.

In a twenty-fourth aspect, in combination with the twenty-third aspect, mapping the user requirement to the sensing resource is based on a sensing mode, an application, a stage of a multi-stage sensing operation, or a use case.

In a twenty-fifth aspect, in combination with one or more of the first aspect through the twenty-fourth aspect, the techniques for performing the monostatic sensing operation include performing at least one stage of a multi-stage sensing operation.

In a twenty-sixth aspect, in combination with one or more of the first aspect through the twenty-fifth aspect, the techniques for performing the monostatic sensing operation include performing a first stage of a multi-stage sensing operation.

In a twenty-seventh aspect, in combination with the twenty-sixth aspect, include determining a result based on the first stage of the multi-stage sensing operation.

In a twenty-eighth aspect, in combination with the twenty-seventh aspect, include mapping, based on the result, a user requirement to a sensing resource.

In a twenty-ninth aspect, in combination with the twenty-eighth aspect, include performing a second stage of the multi-stage sensing operation using the sensing resource.

In a thirtieth aspect, in combination with one or more of the seventeenth aspect through the twenty-ninth aspect, the techniques for performing the monostatic sensing operation include receiving, from a network entity, a report that indicates a result of a first stage of a multi-stage sensing operation.

In a thirty-first aspect, in combination with the thirtieth aspect, the techniques include mapping, based on the result, a user requirement to a sensing resource.

In a thirty-second aspect, in combination with the thirty-first aspect, the techniques include performing a second stage of the multi-stage sensing operation using the sensing resource.

In a thirty-third aspect, in combination with one or more of the twenty-seventh aspect through the thirty-second aspect, the result indicates a blockage location, a mobility of an object, a congestion metric, or a combination thereof.

In a thirty-fourth aspect, in combination with one or more of the first aspect through the thirty-third aspect, the techniques for performing the monostatic sensing operation include performing a first monostatic sensing operation, and performing a second monostatic sensing operation.

In a thirty-fifth aspect, in combination with the thirty-fourth aspect, the first monostatic sensing operation is performed using a first sensing device, and the second monostatic sensing operation is performed using a second sensing device.

In a thirty-sixth aspect, in combination with the thirty-fifth aspect, the first monostatic sensing operation and the second monostatic sensing operation are performed concurrently.

In a thirty-seventh aspect, in combination with the thirty-fifth aspect, the first monostatic sensing device and the second monostatic sensing device are the same device.

In a thirty-eighth aspect, in combination with one or more of the thirty-fourth aspect through the thirty-seventh aspect, the first monostatic sensing operation is a short range sensing operation, and the second monostatic sensing operation is a long range sensing operation.

In a thirty-ninth aspect, in combination with the thirty-fourth aspect the second monostatic sensing operation is performed after the first monostatic sensing operation.

In a fortieth aspect, in combination with the thirty-ninth aspect, the first monostatic sensing operation is associated with a scanning stage, the second monostatic sensing operation is associated with a tracking stage, or a combination thereof.

In one or more aspects, techniques for supporting a sensing charging subscription may include additional aspects, such as any single aspect or any combination of aspects described below or in connection with one or more other processes or devices described elsewhere herein. In a forty-first aspect, techniques for supporting a sensing charging subscription may include receiving charging information associated with a monostatic sensing operation performed by a UE. The charging information is associated with sensing charging subscription information. The techniques may further include generating a sensing charge based on the charging information. In some examples, the techniques in the forty-first aspect may be implemented in a method or process. In some other examples, the techniques of the forty-first aspect may be implemented in a wireless communication device, such as network entity, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a forty-second aspect, in combination with the forty-first aspect, the sensing charging subscription information indicates a functionality, a rule, a profile, or a combination thereof.

In a forty-third aspect, in combination with the forty-first aspect or the forty-second aspect, the techniques further include identifying the sensing charging subscription information associated with monostatic sensing operations performed by the UE.

In a forty-fourth aspect, in combination with the forty-third aspect, the sensing charge is generated based on the sensing charging subscription information.

In a forty-fifth aspect, in combination with the forty-first aspect through the forty-third aspect, the sensing charge is further generated based on a threshold.

In a forty-sixth aspect, in combination with the forty-fifth aspect, the threshold is associated a resource, power, a sensing quality of service, or a combination thereof.

In a forty-seventh aspect, in combination with one or more of the forty-first aspect through the forty-sixth aspect, an action associated with the monostatic sensing operation is based on the threshold.

In a forty-eighth aspect, in combination with the forty-seventh aspect, the action is associated with use of a first quality of service, a charge based on a second quality of service, or termination of the sensing charging subscription information.

In a forty-ninth aspect, in combination with one or more of the forty-first aspect through the forty-eighth aspect, the techniques further include receiving a sensing service usage report based on the monostatic sensing operation.

In a fiftieth aspect, in combination with the forty-ninth aspect, the sensing charge is further generated based on the sensing service usage report.

In a fifty-first aspect, in combination with the forty-ninth aspect or the fiftieth aspect, the sensing service usage report includes the charging information.

In a fifty-second aspect, in combination with the fifty-first aspect, the sensing charge is further generated based on a time period during which the sensing charging subscription information is valid.

In a fifty-third aspect, in combination with the fifty-first aspect, the sensing service usage report is generated based on a mode-2 operation of the UE.

In a fifty-fourth aspect, in combination with the fifty-first aspect, the sensing service usage report indicates a time domain parameter, a frequency domain parameter, a beam direction, a beam bandwidth, a power transmission over time-frequency-space, a quality of service, a resource pool, or a combination thereof.

In a fifty-fifth aspect, in combination with one or more of the forty-first aspect through the fifty-second aspect, the techniques further include transmitting a sensing service request.

In a fifty-sixth aspect, in combination with the fifty-fifth aspect, the techniques further include receiving a configuration acknowledgement signal that indicates that the monostatic sensing operation was performed based on the sensing service request.

In a fifty-seventh aspect, in combination with the fifty-fifth aspect or the fifty-sixth aspect, the sensing service request indicates a quality of service, a threshold quality of service range, or a combination thereof.

In a fifty-eighth aspect, in combination with one or more of the forty-first aspect through the fifty-seventh aspect, the monostatic sensing operation includes a multi-stage sensing operation.

In a fifty-ninth aspect, in combination with one or more of the forty-first aspect through the fifty-eighth aspect, the techniques further include transmitting a report that indicates a result of a first stage of a multi-stage sensing operation.

In a sixtieth aspect, in combination with the fifty-ninth aspect, the result indicates a blockage location, a mobility of an object, a congestion metric, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
performing a monostatic sensing operation; and
generating charging information associated with the monostatic sensing operation, the charging information associated with sensing charging subscription information.

2. The method of claim 1, further comprising:
identifying the sensing charging subscription information associated with monostatic sensing operations, the sensing charging subscription information indicates a functionality, a rule, a profile, or a combination thereof; and
transmitting the charging information, the charging information is generated based on the sensing charging subscription information.

3. The method of claim 1, further comprising:
receiving, at a virtual network function of the UE, a sensing service usage request, the virtual network function includes a charging trigger function (CTF); and generating one or more trigger events based on the sensing service usage request.

4. The method of claim 1, wherein a sensing charge is generated based on the sensing charging subscription information.

5. The method of claim 4, wherein:
the sensing charge is further generated based on a threshold, the threshold is associated a resource, power, a sensing quality of service, or a combination thereof; an action associated with the monostatic sensing operation is based on the threshold, the action is associated with a first quality of service, a charge based on a second quality of service, termination of a subscription associated with the sensing charging subscription information; or
a combination thereof.

6. The method of claim 4, further comprising:
generating, based on a mode-2 operation of the UE, a sensing service usage report based on the monostatic sensing operation, a time period during which the sensing charging subscription information is valid, or a combination thereof, and wherein the sensing service usage report indicates a time domain parameter, a frequency domain parameter, a beam direction, a beam bandwidth, a power transmission over time-frequency-space, a quality of service, a resource pool, or a combination thereof, and
wherein the sensing charge is further generated based on the sensing service usage report.

7. The method of claim 1, further comprising:
receiving a sensing service request that indicates a quality of service, a threshold quality of service range, or a combination thereof; and
transmitting, during a mode-1 operation of the UE, a configuration acknowledgement signal that indicates that the monostatic sensing operation was performed based on the sensing service request.

8. The method of claim 1, further comprising:
determining a user requirement associated with the monostatic sensing operation; and
based on a sensing mode, an application, a stage of a multi-stage sensing operation, or a use case, mapping the user requirement to a sensing resource, and wherein the sensing resource is used to perform the monostatic sensing operation.

9-11. (canceled)

12. A user equipment (UE) comprising:
a sensing device configured to perform a monostatic sensing operation;
a memory storing processor-readable code; and
at least one processor coupled to the memory, the at least one processor configured to execute the processor-readable code to cause the at least one processor to generate charging information associated with the monostatic sensing operation, the charging information associated with sensing charging subscription information.

13. The UE of claim 12, wherein the at least one processor is configured to execute the processor-readable code to cause the at least one processor to:
identify the sensing charging subscription information associated with monostatic sensing operations, the sensing charging subscription information indicates a functionality, a rule, a profile, or a combination thereof; and
transmit the charging information, the charging information is generated based on the sensing charging subscription information.

14. The UE of claim 12, wherein the at least one processor is configured to execute the processor-readable code to cause the at least one processor to:
receive, at a virtual network function, a sensing service usage request, the virtual network function includes a charging trigger function (CTF); and
generate one or more trigger events based on the sensing service usage request.

15. The UE of claim 12, wherein:
a sensing charge is generated based on the sensing charging subscription information and a threshold, the threshold is associated a resource, power, a sensing quality of service, or a combination thereof; and
an action associated with the monostatic sensing operation is based on the threshold, the action is associated with a first quality of service, a charge based on a second quality of service, termination of a subscription associated with the sensing charging subscription information.

16. The UE of claim 12, wherein:
the at least one processor is configured to execute the processor-readable code to cause the at least one processor to generate, based on a mode-2 operation of the UE, a sensing service usage report based on the monostatic sensing operation, a time period during which the sensing charging subscription information is valid, or a combination thereof;
the sensing service usage report indicates a time domain parameter, a frequency domain parameter, a beam direction, a beam bandwidth, a power transmission over time-frequency-space, a quality of service, a resource pool, or a combination thereof; and a sensing charge is generated based on the sensing charging subscription information and the sensing service usage report.

17. The UE of claim 12, wherein the at least one processor is configured to execute the processor-readable code to cause the at least one processor to:
receive a sensing service request that indicates a quality of service, a threshold quality of service range, or a combination thereof; and
transmit, during a mode-1 operation of the UE, a configuration acknowledgement signal that indicates that the monostatic sensing operation was performed based on the sensing service request.

18. The UE of claim 12, wherein the at least one processor is configured to execute the processor-readable code to cause the at least one processor to:
determine a user requirement associated with the monostatic sensing operation; and
based on a sensing mode, an application, a stage of a multi-stage sensing operation, or a use case, map the user requirement to a sensing resource, and wherein the sensing resource is used to perform the monostatic sensing operation.

19. The UE of claim 12, wherein, to perform the monostatic sensing operation, the at least one processor is configured to execute the processor-readable code to cause the at least one processor to:
perform a first stage of a multi-stage sensing operation;
determine a result based on the first stage of the multi-stage sensing operation, the result indicates a blockage location, a mobility of an object, a congestion metric, or a combination thereof;
map, based on the result, a user requirement to a sensing resource; and perform a second stage of the multi-stage sensing operation using the sensing resource.

20. The UE of claim 12, wherein, to perform the monostatic sensing operation, the at least one processor is configured to execute the processor-readable code to cause the at least one processor to:
receive, from a network entity, a report that indicates a result of a first stage of a multi-stage sensing operation, the result indicates a blockage location, a mobility of an object, a congestion metric, or a combination thereof;
map, based on the result, a user requirement to a sensing resource; and perform a second stage of the multi-stage sensing operation using the sensing resource.

21-27. (canceled)

28. A network entity comprising:
a memory storing processor-readable code; and
at least one processor coupled to the memory, the at least one processor configured to execute the processor-readable code to cause the at least one processor to:
receive charging information associated with a monostatic sensing operation performed by a user equipment (UE), the charging information associated with sensing charging subscription information; and
generate a sensing charge based on the charging information.

29. The network entity of claim 28, wherein the at least one processor is configured to execute the processor-readable code to cause the at least one processor to.
identify the sensing charging subscription information associated with monostatic sensing operations performed by the UE, and
wherein the sensing charge is generated based on the sensing charging subscription information, and
wherein the sensing charging subscription information indicates a functionality, a rule, a profile, or a combination thereof.

30. The network entity of claim 28, wherein the at least one processor is configured to execute the processor-readable code to cause the at least one processor to.
receive a sensing service usage report based on the monostatic sensing operation, the sensing service usage report indicates a time domain parameter, a frequency domain parameter, a beam direction, a beam bandwidth, a power transmission over time-frequency-space, a quality of service, a resource pool, or a combination thereof, and
wherein the sensing charge is further generated based on the sensing service usage report.
